(19) United States
(12) Patent Application Publication
(10) Pub. No.: US 2014/0150233 A1
(43) Pub. Date: Jun. 5, 2014

(54) APPARATUS AND METHODS FOR MOUNTING A MULTIUSER TOUCH SENSITIVE DISPLAY DEVICE

(71) Applicant: EMO2 INC., Palo Alto, CA (US)

(72) Inventor: Mir Abid HUSSAIN, Kerala (IN)

(73) Assignee: EMO2 INC., Palo Alto, CA (US)

(21) Appl. No.: 13/691,188

(22) Filed: Nov. 30, 2012

(51) Int. Cl. G06F 3/041

(52) U.S. Cl. CPC G06F 3/041
USPC 29/428

(57) ABSTRACT

A method is provided for mounting a multiuser touch screen display device having a touch sensitive display screen to a platform such that a plurality of users can simultaneously interact with the multiuser touch screen display device running at least one application program for each of the plurality of users through the touch sensitive display screen. The method includes making an opening defined on a surface of a platform that can receive the multiuser touch screen display device such that the display device is accessible to users when the display device is mounted; engaging with the platform a holder configured to hold the multiuser touch sensitive display device such that the holder can receive the multiuser touch sensitive display device through the opening; and mounting the multiuser touch sensitive display device to the platform by placing the display device in the holder through the opening on the platform.

### CROSS REFERENCE TO RELATED APPLICATIONS

This application is related to the following applications filed concurrently herewith on Nov. 30, 2012:

U.S. patent application Ser. No. ______, entitled “Systems and Methods for Changing Orientation of Display Windows and Contents;”

U.S. patent application Ser. No. ______, entitled “Systems and Methods for Controlling a User's Ability to Browse the Internet;”

U.S. patent application Ser. No. ______, entitled “Systems and Methods for Authenticating a User Based on Multiple Inputs Received from Multiple Devices;”

U.S. patent application Ser. No. ______, entitled “Systems and Methods for Selectively Delivering Messages to Multiuser Touch Sensitive Display Devices;” and

U.S. patent application Ser. No. ______, entitled “Systems and Methods for Processing Simultaneously Received User Inputs.”

### FIELD OF THE INVENTION

The disclosed subject matter relates to mounting touch sensitive device, pen-based input devices, and gesture input based devices to a horizontal or vertical platform.

### DISCUSSION OF THE RELATED FIELDS

Usage of touch sensitive devices has increased over the years. For example, Automated Teller Machines (ATMs) adopt touch sensitive devices to receive inputs from users and display information to the users. In ATMs, touch sensitive device is received by an enclosure, which is specially configured to receive the touch sensitive device. Further, the configuration used in such enclosures appears to be fairly complex. Such a mechanism may not be economically feasible if a touch sensitive device had to be configured with a table, such as a coffee or dining table. Similarly, such a mechanism may not be economically feasible if a touch sensitive device had to be configured to a vertical platform, such as a door. As an example let us consider a café chain which is well established. The chain has thousands of tables already deployed across various locations. The company then decides to fit a touch-screen display device into each table for customer engagement and feedback needs. It becomes economically infeasible at that point to make so many new replacement tables with the touch screen built-in. Instead with our method, the company only ships the touch sensitive device along with a holder and a glass covering (in-case the device does not come with a glass covering) to protect the screen using which then any local technician at individual café locations can assemble the device into the existing tables.

Further, conventional technologies do not appear to provide a technique to adjust the relative position of the display of the touch sensitive device with respect to the platform to which it is mounted. Neither do they provide a method to protect the touch sensitive display device from vandalism and accidental wear and tear.

### SUMMARY

In light of the foregoing discussion, there is a need for a technique to simplify mounting of touch sensitive device to a horizontal or vertical platform. There is also a need for a technique to adjust the relative position of the display of the touch sensitive device with respect to the platform to which it is mounted. These devices may be coupled to several input peripherals such as cameras, NFC card readers among others and may also add several output devices such as headphones, printers and speakers. Also touch screens may include IR, Capacitive and in-cell technology based touch screens among others.

Accordingly the invention provides mechanism for mounting touch sensitive device to a platform. The mechanism includes a holder configured to receive the touch sensitive device and engage with the platform and a protective glass either part of the device itself or engaged into place as part of the platform.

A method is provided for mounting a multiuser touch screen display device having a touch sensitive display screen to a platform such that a plurality of users can simultaneously interact with the multiuser touch screen display device running at least one application program for each of the plurality of users through the touch sensitive display screen. The method includes making an opening defined on a surface of a platform that can receive the multiuser touch screen display device such that the display device is accessible to users when the display device is mounted; engaging with the platform a holder configured to hold the multiuser touch sensitive display device such that the holder can receive the multiuser touch sensitive display device through the opening, wherein the holder has flanges that are used to fasten the holder to the platform, wherein the holder is configured to adjust a relative position of the display device with respect to the surface of the platform defining the opening; mounting the multiuser touch sensitive display device to the platform by placing the display device in the holder through the opening on the platform such that the touch sensitive display screen can be viewed through the opening; placing a protective glass over the opening such that the protective glass can cover the opening, wherein a gap is maintained between the display device and the protective glass and wherein the gap is filled with a substance; and applying a sealant to edges of the protective glass to prevent contaminants from reaching the display device.

### BRIEF DESCRIPTION OF DRAWINGS

Embodiments are illustrated by way of example and not limitation in the Figures of the accompanying drawings, in which like references indicate similar elements and in which:

FIG. 1 illustrates an exploded view of a touch sensitive device 100 being mounted to a platform 104 of a table 102, in accordance with an embodiment;

FIG. 2 illustrates touch sensitive device 100 mounted to platform 104 of table 102, in accordance with an embodiment;

FIG. 3 illustrates a mechanism to adjust relative position of display of device with respect to surface 114, in accordance with an embodiment; and

FIG. 4 illustrates a mechanism to adjust relative position of display of device with respect to surface 114, in accordance with an embodiment.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

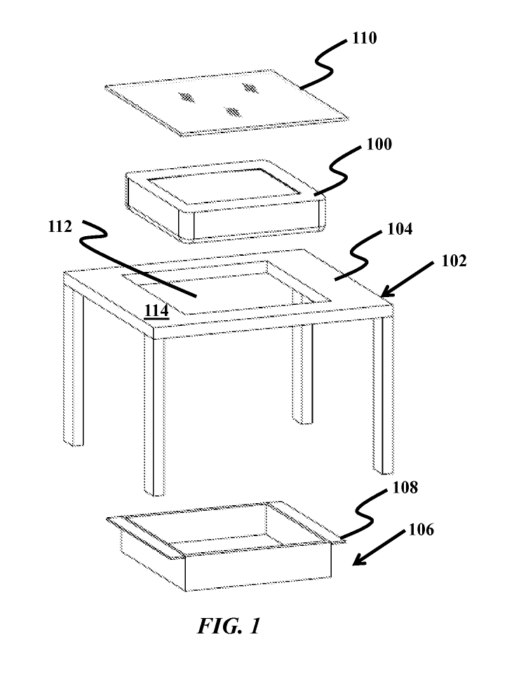

FIG. 1 illustrates an exploded view of a touch sensitive device 100 being mounted to a platform 104 of a table 102, in accordance with an embodiment. Touch sensitive device 100 is received by a holder 106. Device 100 can be engaged with holder 106, for example, by using a VESA mount mechanism. Holder 106 is engaged with platform 104 of table 102. Platform 104 defines an opening 112 through which display of device 100 is accessible to a user after device 100 is mounted to the platform 104.

In an embodiment, as illustrated in FIG. 1, holder 106 can have flanges 108. Flanges 108 can be provided to opposite side walls of holder 106. Alternatively, flanges 108 can be provided on all the side walls of holder 106. Alternatively, flanges 108 can be provided on two or more side walls of holder 106.

Flanges 108 can be engaged with platform 104, thereby engaging holder 106 with platform 104 of table 102. By engaging holder 106 with platform 104, device 100 is engaged with platform 104.

In an embodiment, a protective glass 110 is placed on the platform 104. The protective glass 110 protects device 100 from contaminants or vandalism or accidental wear and tear. This glass may also come as part of the device itself. So at the time of production of device the glass maybe attached into position on top of the screen to protect it. In an embodiment, holder 106 defines perforations.

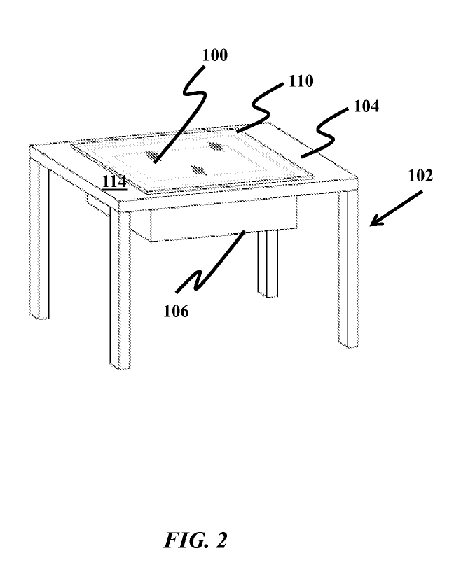

FIG. 2 illustrates touch sensitive device 100 mounted to platform 104 of table 102, in accordance with an embodiment. It shall be noted that, even though a table platform (horizontal) is used as an example to describe embodiments, the described technique can be used to mount device 100 to a vertical platform. Any reference to platform can include horizontal or vertical platform, based on the context.

It shall be noted that, in some embodiments, the relative position of display of device 100 with respect to surface 114 (facing a user) of platform 104 may be of relevance. However, the thickness of platform 104 would have a bearing on the relative position of the display of device 100. Hence, embodiments illustrate mechanism to adjust relative position of display of device 100 with respect to surface 114.

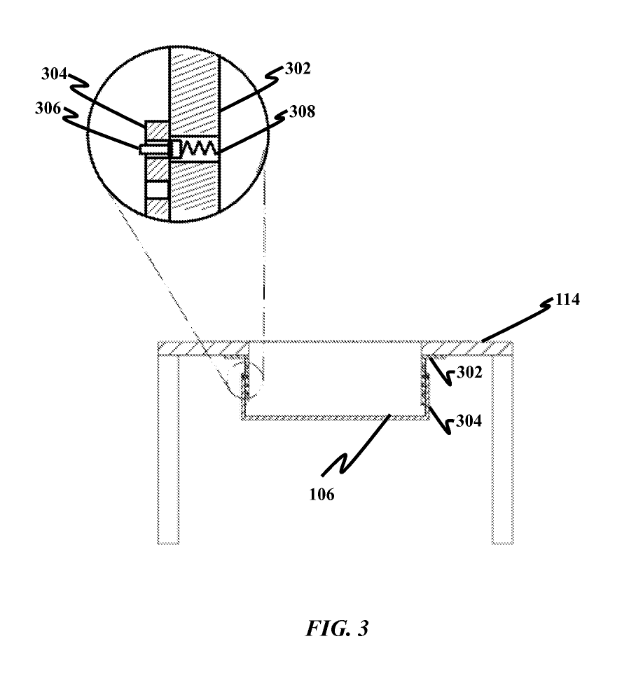

FIG. 3 illustrates a mechanism to adjust relative position of display of device with respect to surface 114, in accordance with an embodiment. Holder 106 includes flanges 302, which are configured to traverse along the height of holder 106. Traverse movement of flanges 302 is enabled by defining holes in side walls 304. In the flanges 302, a spring 308 activated protruding element 306 is provided.

The protruding element 306 engages with a hole defined in the side wall 304. To adjust the height, the protruding element 306 is pushed in, so that the protruding element 306 is substantially moved out of the hole. Thereafter, the flange 302 is moved up or down, as desired. Thereafter, because of the force exerted by spring 308, protruding element 306 is received by another hole defined in the side wall 304. A similar mechanism maybe provided to adjust the width of the holder in-order to widen the holder wherein sometimes a wider holder maybe needed so as to not chip away the surface.

It shall be noted that, one or more protruding elements 306 may be provided. Further, protruding elements 306 may be provided on two or more flanges 302 corresponding to two or more sides of the holder 106.

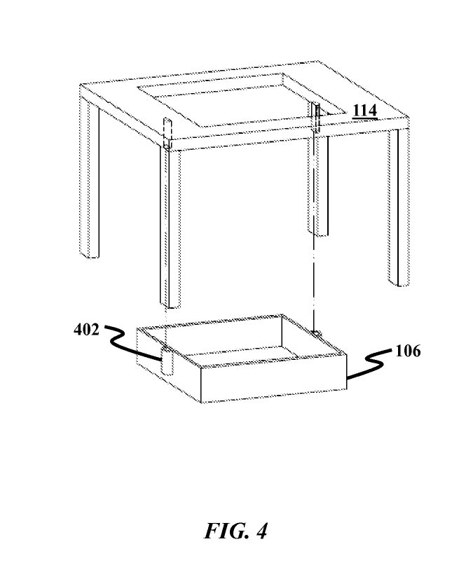

FIG. 4 illustrates a mechanism to adjust relative position of display of device with respect to surface 114, in accordance with an embodiment. Holder 106 is provided with screw receivers 402 on two or more side walls. The height can be adjusted by turning screws in the desired (clockwise or anticlockwise) direction.

In an embodiment, a ratchet pawl mechanism can be used to adjust relative position of display of device with respect to surface 114. In an embodiment, a desired gap may be maintained between display of device 100 and protective glass 110.

In an embodiment, the gap is an air gap. In an embodiment, the gap between display of device 100 and protective glass 110 can be filled by a gel. In an embodiment, a water proof sealant is provided at the edges of the protective glass 110.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus the scope of the invention should be determined by the appended claims and their legal equivalents rather than by the examples given.

What is claimed is:

1. A method for mounting a multiuser touch screen display device having a touch sensitive display screen to a platform such that a plurality of users can simultaneously interact with the multiuser touch screen display device running at least one application program for each of the plurality of users through the touch sensitive display screen, the method comprising:
making an opening defined on a surface of a platform that can receive the multiuser touch screen display device such that the display device is accessible to users when the display device is mounted;
engaging with the platform a holder configured to hold the multiuser touch sensitive display device such that the holder can receive the multiuser touch sensitive display device through the opening, wherein the holder has flanges that are used to fasten the holder to the platform, wherein the holder is configured to adjust a relative position of the display device with respect to the surface of the platform defining the opening;
mounting the multiuser touch sensitive display device to the platform by placing the display device in the holder through the opening on the platform such that the touch sensitive display screen can be viewed through the opening;
placing a protective glass over the opening such that the protective glass can cover the opening, wherein a gap is maintained between the display device and the protective glass and wherein the gap is filled with a substance; and
applying a sealant to edges of the protective glass to prevent contaminants from reaching the display device.

2. The method of claim 1, wherein the holder has at least one openings and at least one peripheral devices are connected to the multiuser touch screen display device through the at least one openings.

3. The method of claim 2, wherein the at least one peripheral devices include at least one of: a printer, a digital camera, and a rear field communication (NFC) reader.

4. A method of claim 1, wherein the protective glass may be attached to the touch screen device before mounting the device into the platform.
